(19) United States
(12) Patent Application Publication
(10) Pub. No.: US 2017/0051488 A1
(43) Pub. Date: Feb. 23, 2017

(54) FITTING STRUCTURE BETWEEN NOZZLE CAP AND MAIN NOZZLE BODY OF BIDET

(71) Applicant: IZEN CO., LTD., Gimpo-si Gyeonggi-do (KR)

(72) Inventor: Min-Soo KIM, Gimpo-si (KR)

(73) Assignee: IZEN CO., LTD., Gimpo-si Gyeonggi-do (KR)

(21) Appl. No.: 15/114,145

(22) PCT Filed: May 14, 2014
(86) PCT No.: PCT/KR2014/004330

§ 371 Date: Jul. 26, 2016

(51) Int. Cl. E03D 9/08; B05B 15/06

(52) U.S. Cl. CPC E03D 9/08; B05B 15/069

(57) ABSTRACT

The present invention provides a fitting structure of a bidet between a nozzle cap and a main nozzle body thereof The structure includes: an elastic disc seal disposed between a plurality of passages of the main nozzle body and a plurality of waterjet passages of the nozzle cap and having a plurality of penetrating holes to communicate the passages with each other and fitted onto the main nozzle body; a stepped male portion formed on the leading end of the main nozzle body and having a recess formed on a part of the outer circumference of the stepped male portion and protrusions formed in the recess; and a tubular female portion fitted on the stepped male portion and a hook formed on the basement end of the tubular female portion and locked by the protrusion to press the protrusion toward the leading end.

### TECHNICAL FIELD

The present invention relates to a fitting structure between a nozzle cap and a main nozzle body and, more particularly, to a fitting structure between a nozzle cap and a main nozzle body of a bidet to allow a seal to be easily attached and detached without any damage to the seal.

### BACKGROUND ART

A bidet is generally designed to jet washing water for anus and female genitals, and especially a nozzle cap of the bidet is detachably attached to a main nozzle body that moves forward and backward for washing of jetting nozzles.

This is described in detail as follows.

The main nozzle body includes a plurality of passages such as a passage for washing anus, a passage for washing genitals, and a passage for regular motion, while the nozzle cap includes a plurality of passages, communicating with the plurality of passages, such as a waterjet passage for washing anus, a waterjet passage for genitals, and a waterjet passage for regular motion.

For the detachable attachment of the main nozzle body and the nozzle cap, a step is formed around a leading outer circumference of the main nozzle body, a protrusion is formed on a part of the step, a seal is inscribed around the leading outer circumference of the step, seals are circumscribed to ends of the plurality of passages exposed from the leading end of the main nozzle body, a plurality of waterjet passages circumscribed to the ends of the plurality of passages in shape and fitted thereonto are formed in a base end of the nozzle cap, a recess circumscribed to the step in shape and fitted thereonto is formed in a base end of the nozzle cap, and a penetrated hole through which the protrusion is inserted and passed is formed in the base end of the nozzle cap.

The seals circumscribed to the ends of the plurality of passages provides a first function of preventing washing water in the plurality of passages and the plurality of the waterjet passages from leaking from a gap between the plurality of passages and the plurality of the waterjet passages in the state that the plurality of passages of the main nozzle body are inscribed to the plurality of waterjet passages of the nozzle cap, and the seal circumscribed to the step provides a second function of preventing the washing water jetted from the plurality of waterjet passages from returning back and entering a space between the main nozzle body and the nozzle cap through a gap between the main nozzle body and the nozzle cap.

However, a structure between the main nozzle body and the nozzle cap as described above has drawbacks that the seals are worn out very quickly and the first and second functions cannot work when the nozzle cap is detached from the main nozzle body periodically for washing jet holes, and as a result the seals should be replaced by new ones.

Moreover, the structure between the main nozzle body and the nozzle cap has shortcoming that, since the nozzle cap is expanded in the diameter by the protrusions of the main nozzle body and climbs over the protrusions, and the protrusions are inserted into penetrating holes formed in the nozzle cap when the nozzle cap is coupled with the main nozzle body, the inner circumferential surface of the nozzle cap is scratched by the protrusions and a gap between the seal and the inner circumferential surface of recesses of the nozzle cap is generated so that the second function cannot be performed, and that, since the nozzle cap should be expanded by a force with a tool such that the protrusions may be escaped from the penetrating holes, the nozzle cap and the main nozzle body may be damaged and it is difficult to separate the nozzle cap from the main nozzle body.

### DISCLOSURE

### Technical Problem

The present invention has been made in view of the above problem.

### Technical Solution

The present invention may be achieved by providing a fitting structure of a bidet between a nozzle cap and a main nozzle body thereof. The structure includes: an elastic disc seal disposed between a plurality of passages of the main nozzle body and a plurality of waterjet passages of the nozzle cap and having a plurality of penetrating holes to communicate the passages with each other and fitted onto the main nozzle body; a stepped male portion formed on the leading end of the main nozzle body and having a recess formed on a part of the outer circumference of the stepped male portion and protrusions formed in the recess; and a tubular female portion fitted on the stepped male portion and having a hook formed on the basement end of the tubular female portion and locked by the protrusion to press the protrusion toward the leading end.

### Advantageous Effects

As described above, the present invention may allow to attach and detach the nozzle cap to and from the main nozzle body through a sliding length shorter than the existing one such that the seals may be worn out less than the existing ones, and allow the hook to be locked by the protrusion when the tubular female portion is circumscribed to the stepped male portion and the nozzle cap is pivoted clockwise by an angle with a hand, and on the contrary the hook to be released from the protrusion when the nozzle cap is pivoted counterclockwise by an angle with a hand, so that the nozzle cap may be easily attached and detached to and from the main nozzle body repeatedly without any damage to the nozzle cap and the main nozzle body, resulting in washing the jetting hole of the nozzle cap easily and preventing the nozzle cap and the main nozzle body being weakened due to the attachment and detachment.

### DESCRIPTION OF DRAWINGS

The objects, features and advantages of the present invention will be more apparent from the following detailed description in conjunction with the accompanying drawings, in which:

FIGS. 1 to 3 are exploded perspective views illustrating a main nozzle body and a nozzle cap according to an exemplary embodiment of the present invention;

FIG. 4 is an exploded perspective view illustrating a disc seal coupled to the main nozzle body;

FIG. 5 is a perspective view illustrating a nozzle cap coupled to the assembly as illustrated in FIG. 4; and

FIG. 6 is a perspective view illustrating the nozzle cap rotated clockwise in the state as illustrated in FIG. 5.

### BEST MODE

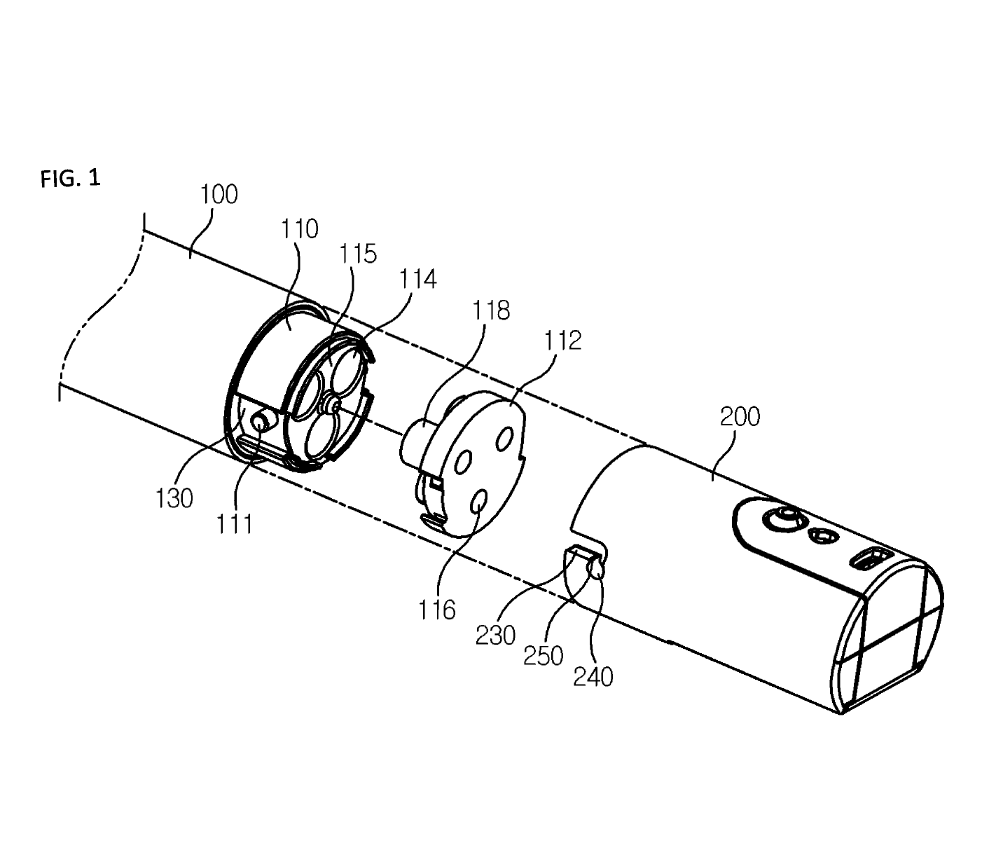

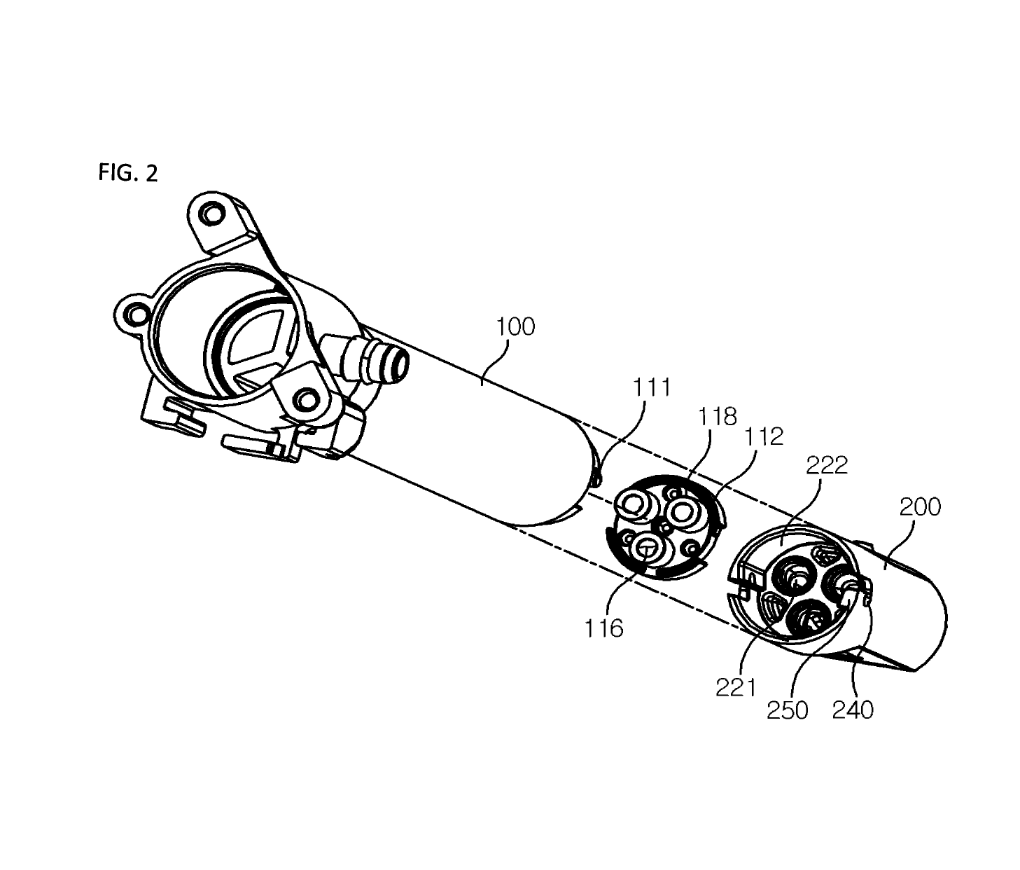

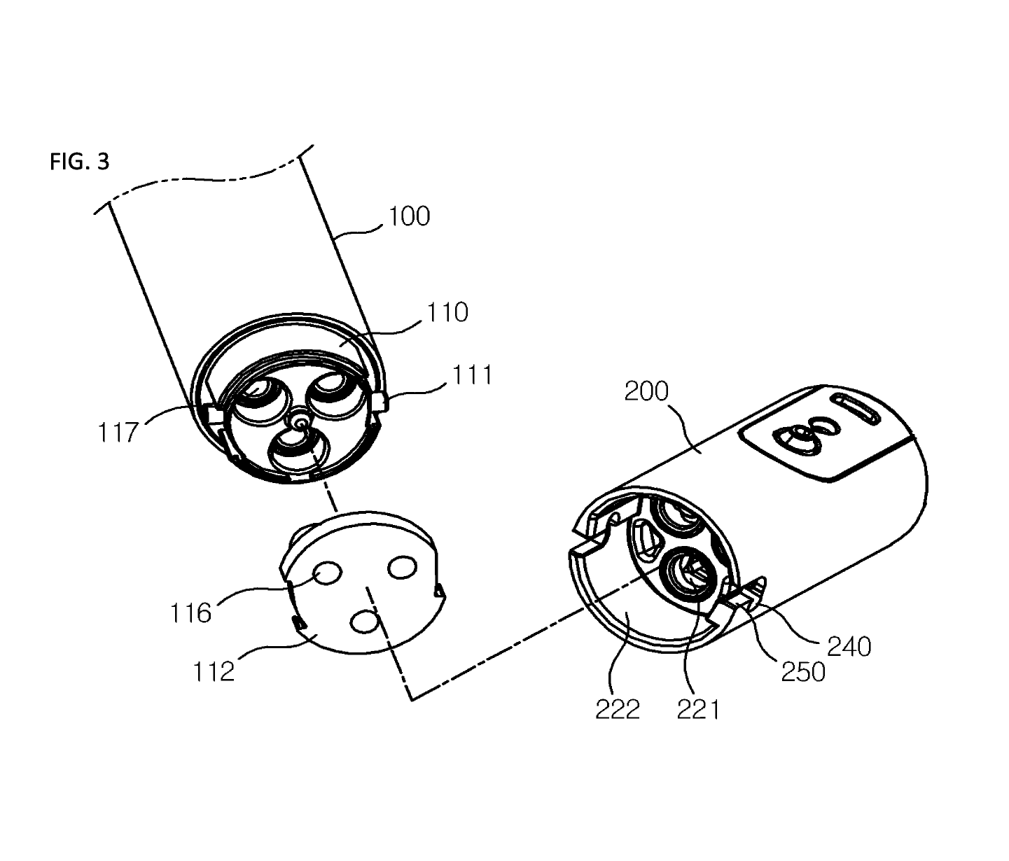

Hereinafter, exemplary embodiments of a fitting structure of a nozzle cap and a main nozzle body of a bidet of the present invention are described in detail with reference to the accompanying drawings FIGS. 1 to 6.

FIGS. 1 to 3 are exploded perspective views illustrating a fitting structure of between a main nozzle body and a nozzle cap according to an exemplary embodiment of the present invention.

As illustrated in FIGS. 1 to 3, the main nozzle body 100 is formed with a stepped male portion 110 formed around the outer leading circumference of the main nozzle body 100, the stepped male portion 110 has recesses 130 formed on parts of the outer circumference thereof, and each of the recesses 130 has a cylindrical protrusion 111 protruding out in the radial direction.

The main nozzle body 100 has a seat 115 on which an elastic disc seal 112 is seated, and the disc seal 112 has a plurality of penetrating holes 116 for communicating a plurality of passages 114 of the main nozzle body 100 with a plurality of waterjet passages 221 of the nozzle cap 200 respectively in the state that the nozzle cap 200 is coupled with the main nozzle body 100.

Moreover, the disc seal 112 has a plurality of tubular male portions 118 formed on a basement surface with a leading end communicated with the plurality of penetrating holes 116 and extending to the basement side, and integrated with a basement of the disc seal 112 and inserted into the plurality of passages 114 to be seated on a seal male portion 117 formed in respective leading ends of the plurality of passages 114 of the main nozzle body 100, so that the disc seal 112 is prevented from rotating in the seat 115 of the main nozzle body 100.

The basement of the nozzle cap 200 is integrated with a tubular female portion 222 circumscribed to and fitted into the stepped male portion 110 of the main nozzle body and communicating with the plurality of waterjet passages 221.

The tubular female portion 222 has a rectangular guide cut-off portion 230 formed at portions facing the cylindrical protrusions 111 and having the same width as a diameter of the cylindrical protrusions 111, the guide cut-off portion 230 has a hook 240 formed on a wall in the counterclockwise direction of the leading end thereof and positioned to move the nozzle cap 200 toward the main nozzle body 100 further and to press the elastic disc seal 122.

The inner circumference of the tubular female portion 222 facing the counterclockwise wall of the leading end of the guide cut-off portion 230 on which the hook 240 is formed is a thick wall 250, such that the hook 240 may be prevented from being deformed or damaged even when the tubular protrusions 111 are locked by the hooks 240 and the hook 240 is applied with a tensile force by the cylindrical protrusions 111.

The recesses 130 formed in the stepped male portion 110 are provided such that the main nozzle body 100 may be easily coupled with the nozzle cap 200 without any hindrance.

The above-described main nozzle body 100 and nozzle cap 200 may be attached and detached to and from each other as follows.

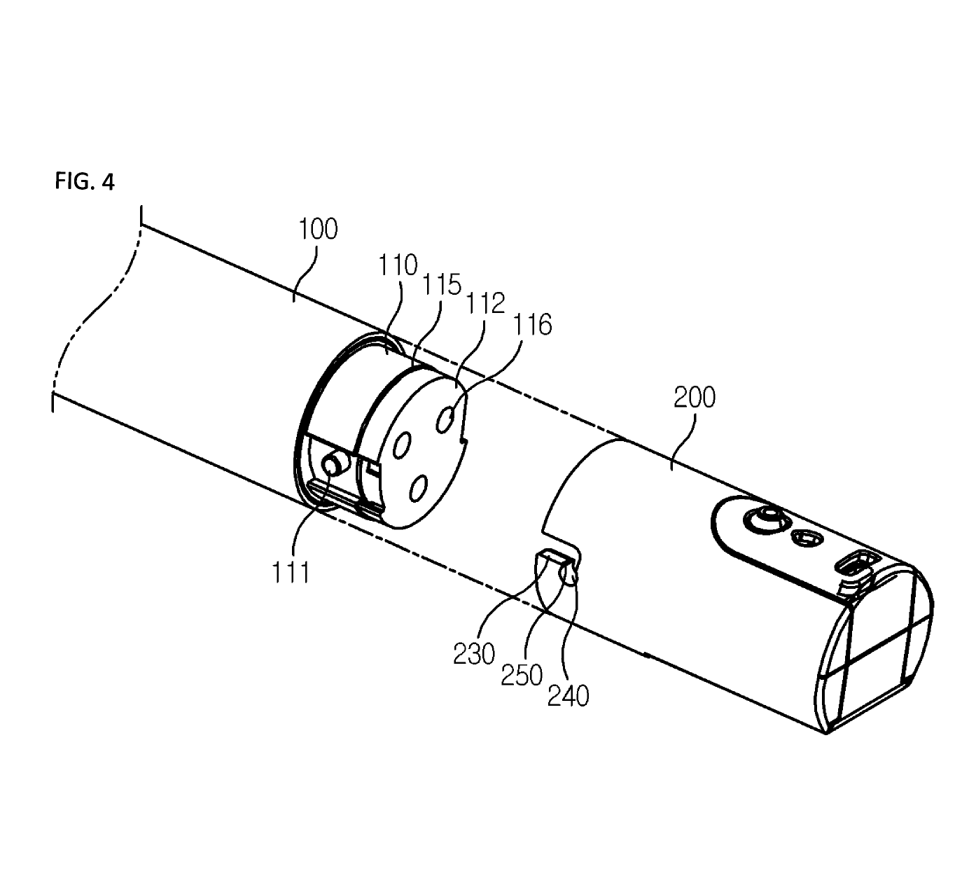

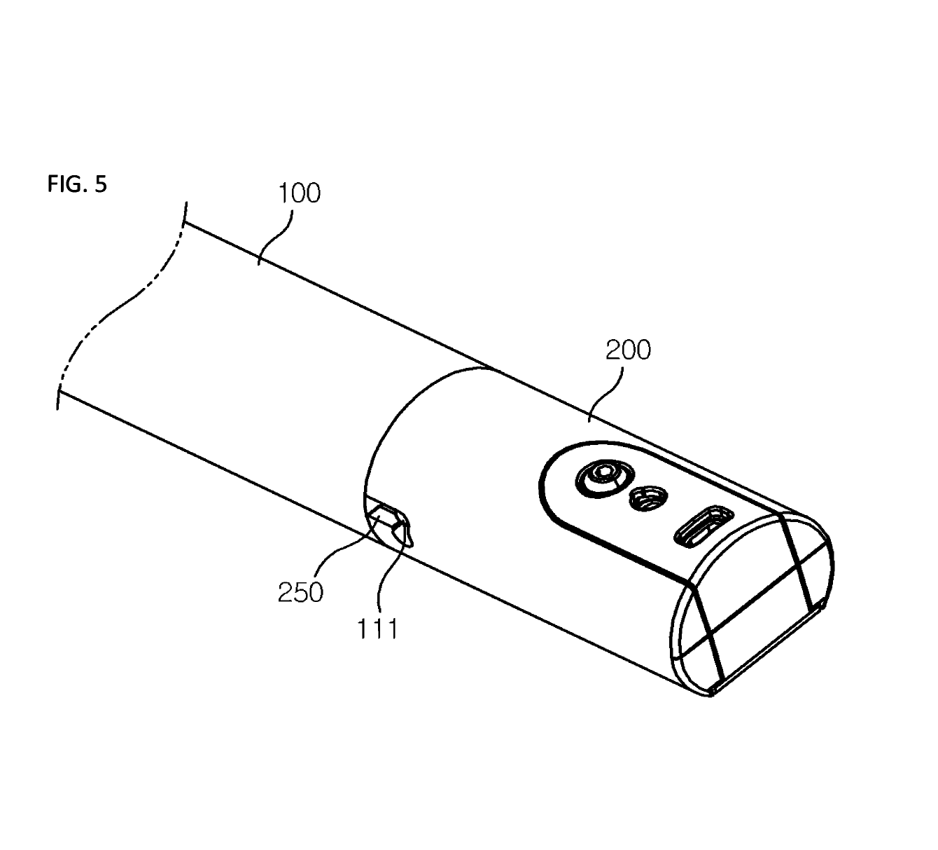

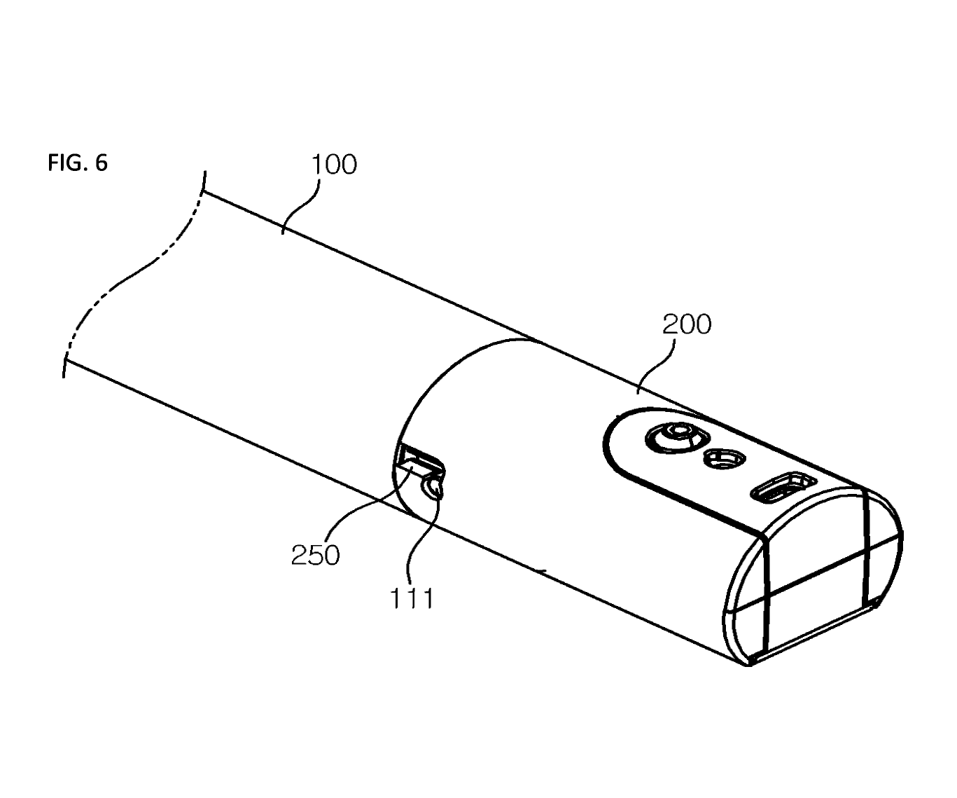

For the attachment, as illustrated in FIG. 4, the disc seal 112 is seated on the seat 115 and the tubular female portion 222 is circumscribed to the stepped male portion 110 and is rotated while fitting thereinto such that the guide cut-off portions 230 of the tubular female portions 222 are fitted onto the cylindrical protrusions 111. After that, as illustrated in FIG. 5, when the nozzle cap 200 is pushed toward the main nozzle body 100, the cylindrical protrusions 111 are guided by the guide cut-off 230 to be in contact with the leading end wall of the guide cut-off 230. In this state, as illustrated in FIG. 6, when the nozzle cap 200 is rotated clockwise, the cylindrical protrusions 111 enter the hook and the nozzle cap 200 is further pushed into the main nozzle body 100 such that the elastic disc seal 112 is pressed. As a result, the plurality of waterjet passages 221 of the nozzle cap 200 communicate with the plurality of passages of the main nozzle body 100 oiltightly so that the nozzle cap 200 is securely fitted into the main nozzle body 100 not to be released by an unexpected external force.

The sequence of the detachment is the inverse sequence of the attachment.

The above-described fitting structure between the main nozzle body and the nozzle cap according to the embodiment of the present invention may allow to attach and detach the nozzle cap 200 to and from the main nozzle body 100 through a sliding length shorter than the existing one such that the seals 112 may be worn out less than the existing ones, the hook 240 is locked by the protrusion 111 when the tubular female portion 222 is circumscribed to the stepped male portion 110 and the nozzle cap 200 is pivoted clockwise by an angle with a hand, and on the contrary the hook 240 is released from the protrusion 111 when the nozzle cap 200 is pivoted counterclockwise by an angle with a hand, so that the nozzle cap 200 may be easily attached and detached to and from the main nozzle body 100 repeatedly without any damage to the nozzle cap 200 and the main nozzle body 100, resulting in washing the jetting hole of the nozzle cap 200 easily and preventing the nozzle cap 200 and the main nozzle body 100 being weakened due to the attachment and detachment.

In the embodiment, if a single recess 130 and a single tubular protrusion 111 are formed on the main nozzle body 100, a single cut-off portion 230 and a single hook 240 are also formed on the nozzle cap 200. If a plurality of the recesses 130 and the tubular protrusions 111 are formed on the main nozzle body 100 by a same phase difference, in correspondence to that a plurality of cut-off portions 230 and a plurality of hooks 240 may be also formed on the nozzle cap 200 by the same phase difference.

1. A fitting structure between a nozzle cap and a main nozzle body of the bidet, comprising:
a stepped male portion (110) formed outer circumference of the main nozzle body (100);
a cylindrical protrusion (111) protruding out in the radial direction from a part of the outer circumference of the stepped male portion (110);
a seat (115), formed on the leading end of the main nozzle body (100), on which an elastic disc seal (112) seats;
wherein the disc seal (112) includes a plurality of penetrating holes (116) to communicate a plurality of passages (114) of the main nozzle body (100) with a plurality of waterjet passages (221) of the nozzle cap (200) when the main nozzle body (100) is coupled with the nozzle cap (200);
the nozzle cap (200) includes a tubular female portion (220) integrated to a basement thereof to communicate with the plurality of the waterjet passages (221) and to be fitted on the stepped male portion (110) of the main nozzle body (100);
the tubular female portion (222) has a rectangular guide cut-off (230) formed on a portion facing the cylindrical protrusion (111) and having the same width as a diameter of the cylindrical protrusion (111); and
the guide cut-off (230) includes a hook (240) formed on a wall in the counterclockwise direction of the leading end of the guide cut-off (230) and positioned to move the nozzle cap (200) toward the main nozzle body (100) further and to press the elastic disc seal (112).

2. The fitting structure of claim 1, wherein the disc seal (112) includes a plurality of tubular male portions (118) integrated with the basement surface and having leading ends communicated with the plurality of penetrating holes (116) and basement ends extending toward the basement ends and inserted into the plurality of passages (114) to be seated on the seal female portions (117) formed on the respective leading ends of the plurality of the passages (114) of the main nozzle body (100).

3. The fitting structure as claimed in claim 1, wherein the inner circumference of the tubular female portions (222) facing the counterclockwise walls of the leading ends of the guide cut-offs (230) on which the hooks (240) are formed are thick walls (250); and
recesses (130) are formed around the stepped male portions (110) on which the cylindrical protrusions (111) are formed to allow the main nozzle body (100) to be coupled with the nozzle cap (200) easily without any hindrance.

4. The fitting structure as claimed in claim 2, wherein the inner circumference of the tubular female portions (222) facing the counterclockwise walls of the leading ends of the guide cut-offs (230) on which the hooks (240) are formed are thick walls (250); and
recesses (130) are formed around the stepped male portions (110) on which the cylindrical protrusions (111) are formed to allow the main nozzle body (100) to be coupled with the nozzle cap (200) easily without any hindrance.
